(19) United States
(12) Patent Application Publication
(10) Pub. No.: US 2003/0117763 A1
(43) Pub. Date: Jun. 26, 2003

(54) Capacitor and a process for electrically connecting electrode layers to a point of connection

(76) Inventor: Joseph Connolly, Wirral (GB)

Correspondence Address: Nixon & Vanderhye, 8th Floor, 1100 North Glebe Road, Arlington, VA, 22201-4714, US

(21) Appl. No.: 10/182,334

(22) PCT Filed: Jan. 24, 2001
(86) PCT No.: PCT/SE01/00117

(30) Foreign Application Priority Data
Jan. 26, 2000 (SE) 0000239-4

(51) Int. Cl. H01G 4/32

(52) U.S. Cl. 361/301.5

(57) ABSTRACT

A capacitor including a capacitor element (1) that has a roll (4) of alternate dielectric layers (8) and electrode layers (9), which roll has two end surfaces (5, 6), in which the electrode layers are connectably exposed, and two contact elements that are electrically connected to the electrode layers at the end surfaces. In accordance with the invention, at least one of the contact elements includes a contact part (10, 11) which, before being connected to the electrode layers at the end surface, displays a plurality of through-running openings (15) through which a flame-sprayed metal material is affixed to attach the contact part to the end surface. The invention also relates to a process for electrically connecting the electrode layers in such a capacitor element to an external predetermined connection point.

### TECHNICAL FIELD

The present invention relates to a capacitor including at least one capacitor element that includes at least one roll of alternate dielectric layers and electrode layers, which roll has first and second end surfaces facing away from each other, in which said electrode layers are connectably exposed, and two contact elements that are electrically connected to the electrode layers at the end surfaces.

The invention also relates to a process for electrically connecting the electrode layers to an external predetermined connection point in such a capacitor element.

### BACKGROUND ART

In power capacitors, it is known to use capacitor elements in the form of rolls with two substantially parallel end surfaces. In such a roll, dielectric films and metallic electrode material are arranged circumferentially so that, in its radial direction, the roll has alternate dielectric layers and electrode layers, which electrode layers couple to each other capacitively through the dielectric layers. At the end surfaces of the roll, the electrode layers emerge so that they are electrically connectable.

When manufacturing a commonly employed conventional power capacitor comprising capacitor elements of the wound type described above, a plurality of flattened rolls are arranged one above the other in a stack so that the end surfaces of the rolls on one side coincide in one plane and so that the end surfaces of the roll on the other side coincide in another plane. An electrically conducting material, usually a zinc alloy, is flame-sprayed onto the end surfaces in each plane so that the flame-sprayed material electrically connects to the protruding electrode layers and forms a “metal cake”. A busbar or ribbon is then arranged along the end surfaces, whereupon the busbar is fixed to the flame-sprayed, solidified material by soldering. The busbar is finally connected to one of the connection terminals of the power capacitor via a connection wire, usually a braided copper wire, one end of which is soldered onto the busbar and the other end of which is soldered onto the connection terminal. The electric link between the connection terminal and the electrode layers thus consists of connection wire, busbar, and flame-sprayed, solidified material in the form of a metal cake.

Upon extreme discharge currents, an impaired electric connection can occur between the connection terminal and the electrode layers in some cases. Even moderate impairment of the electric connection is serious, as this can lead to Jouleian losses causing heating of the power capacitor.

A very high degree of skill is needed to prevent the end surfaces of the capacitor element from being damaged from the heat generated when the busbar is soldered onto the metal cake in power capacitors where the film and electrode layers are made up of thin, metallized dielectric films. Thus, the soldering process is sensitive and time-consuming and requires skilled workers.

### DESCRIPTION OF THE INVENTION

The object of the present invention is to significantly reduce the above-mentioned problems and, in a capacitor, to provide a safe, simple and cost-effective electric connection between a predetermined connection point and a plurality of electrode layers occurring in a capacitor element.

The above-mentioned object is achieved with a capacitor in accordance with the invention, which is characterized in that at least one of said contact elements includes a contact part which, before being connected to the electrode layers at the end surface as aforesaid, displays a plurality of through-running openings in which an electrically conducting attachment aid in the form of a flame-sprayed metal material is affixed to attach the contact part to the end surface.

The process is characterized in that it includes the following steps:

a) attaching a first end of an electrically conducting connection wire to a contact part displaying a plurality of through-running openings,

b) arranging the contact part by the end surface in electric contact with the connectable electrode layers,

c) attaching the contact part to the end surface with the aid of an attachment aid in the form of a metal material that is flame-sprayed onto the end surface through the through-running openings of the contact part and causing the metal material to solidify and attach the contact part to the end surface, and

d) attaching the other end of the connection wire to the predetermined connection point.

### DESCRIPTION OF THE DRAWINGS

The invention will be further explained in the following with reference to the drawings, where

FIG. 1 shows a capacitor element and two contact elements electrically connecting to electrode layers in the capacitor element,

FIG. 2 shows the capacitor element and parts of the contact elements from FIG. 1, the contact parts comprised in the contact elements in accordance with a first embodiment of the invention being illustrated,

FIG. 3 shows a contact part in accordance with a second embodiment of the invention,

FIG. 4 shows a capacitor in accordance with the invention,

FIG. 5 shows a contact part in accordance with yet another embodiment of the invention,

FIG. 6 shows yet another capacitor in accordance with the invention,

FIG. 7 shows a capacitor element in accordance with an alternative embodiment of the invention, and

FIG. 8 shows two capacitor elements, series-connected, of the type shown in FIG. 7.

### DESCRIPTION OF PREFERRED EMBODIMENTS

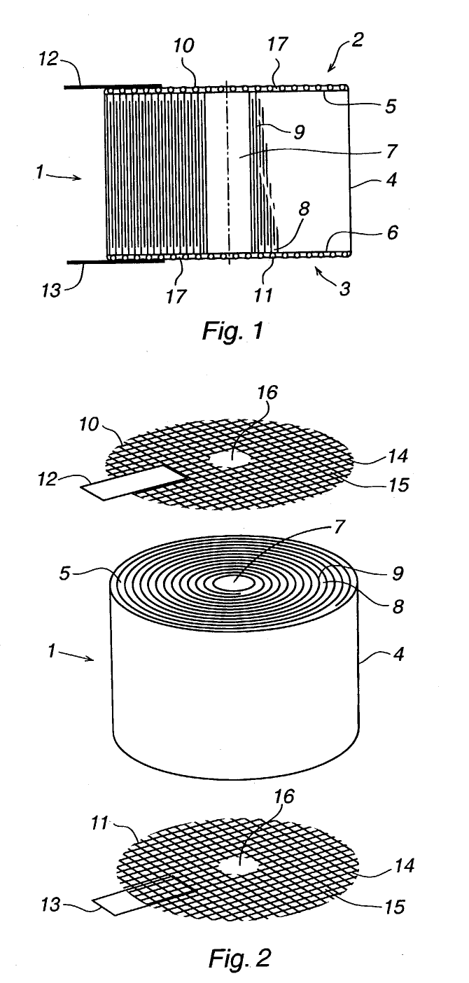

FIG. 1 shows a cross-section of a capacitor element 1 and two contact elements 2, 3. The capacitor element 1 has the shape of a substantially annular-cylindrical roll 4 with two substantially parallel end surfaces 5, 6 and displays, about its central axis, a substantially annular-cylindrical through-running central channel 7. Metallized dielectric films or pairs of dielectric films and metal foil are arranged circumferentially in the roll 4 such that, in the radial direction, the roll 4 displays a large number of alternate dielectric layers 8 and electrode layers 9. The electrode layers 9 are arranged such that they are capacitively coupled to each other through the dielectric layers 8. Some of the electrode layers 9 are exposed at one of the end surfaces 5 of the capacitor element 1 so that they emerge there at right angles to the same. Other electrode layers 9 are exposed at the other end surface 6 of the capacitor element 1 so that they emerge there in the same way. The electrode layers 9 are thus electrically connectable at the end surfaces 5, 6. Each contact element 2, 3 comprises a contact part 10, 11, a connection wire 12, 13, attached to the contact part 10, 11, and an attachement aid 17, which fixes the contact part 10, 11 to the end surface 5, 6. FIG. 2 shows the capacitor element 1 and the contact parts 10, 11 with the connection wires 12, 13 in a position prior to the contact parts 10, 11 being fixed to the end surfaces 5, 6 of the capacitor element 1. In the present embodiment, each contact part 10, 11 consists of a plurality of metal threads 14, preferably of tin-plated copper, which are arranged in a predetermined, loose pattern so that they connect with each other electrically at their intersection points and define between them through-running openings 15 in the contact part 10, 11. Thus, in this embodiment, the contact parts 10, 11 have mesh-like structure, where the openings 15 consist of the interstices in the mesh. The shape of the contact parts 10, 11 in this case substantially coincides with the shape of the end surfaces 5, 6, i.e. the contact parts 10, 11 are circular and feature a concentric, circular hole 16 in their central parts. The connection wires 12, 13 attached to the contact parts 10, 11 can consist of a copper braid or copper strip, for instance.

In accordance with the invention, to provide an electric coupling at the end surface 5 between the electrode layers 9 and a predetermined connection point (not shown), separate from the capacitor element 1, for instance a connection terminal in a capacitor or connection wire belonging to a second capacitor element, the connection wire 12 is initially attached to the contact part 10, preferably by soldering. Thereafter, the contact part 10 is arranged at the end surface 5 so that the hole 16 of the contact part 10 coincides with the central channel 7 of the capacitor element 1 and so that the contact part 10 is caused to contact the connectable electrode layers 9 on the surface 5. Thereafter, the contact part 10 is fixed to the end surface 5 with the aid of said attachment aid 17, which is affixed through said openings 15 in the contact part 10. The attachment aid 17 preferably constitutes a metal material, flame-sprayed onto the end surface 5 via the openings 15 in the contact part 10. Thus, the flame-sprayed material penetrates the openings 15 of the contact part 10 and impinges on the underlying end surface 5, whereupon the flame-sprayed material solidifies and fixes the contact part 10 to the end surface 5. Finally, the electric circuit is completed by the connection wire 12 being connected to the predetermined connection point. To provide an electric coupling by the end surface 6 between the connectable electrode layers 9 on the end surface 6 and a second connection point (not shown), the same procedure is executed with the contact part 11 and the connection wire 13. FIG. 1 shows the capacitor element 1 and the finished contact elements 2, 3, where the contact parts 10, 11 are fixed to the end surfaces 5, 6, respectively, by means of the attachment aid 17. The attachment aid 17 is preferably electrically conducting, the electric contact between the contact parts 10, 11 and the electrode layers 9 being supplied in part by the contact parts 10, 11 directly abutting the electrode layers 9 and in part by the attachment aid 17.

In accordance with an alternative process in accordance with the invention, the end surfaces 5, 6 are initially flame-sprayed with a first metal material to form a first electrically conducting flame-sprayed layer, electrically connecting with the electrode layers 9. Thereafter, the contact parts 10, 11 (with attached connection wires 12, 13) are arranged by the end surfaces 5, 6 so that the contact parts 10, 11 connect electrically with the first flame-sprayed layer. Thereafter, the contact parts 10, 11 are fixed to the first flame-sprayed layer with the aid of the attachment aid 17. The attachment aid 17 is preferably a second metal material that is flame-sprayed onto the first flame-sprayed layer via the openings 15 of the contact parts 10, 11, solidifies to a second electrically conducting flame-sprayed layer and fixes the contact parts 10, 11 to the first flame-sprayed layer. Finally, the connection wires 12, 13 are connected to suitable connection points. Preferably, the particles in the first flame-sprayed layer, the function of which is to form a good electric connection with the electrode layers 9 on each of the end surfaces 5, 6, are of a smaller size than the particles in the second flame-sprayed layer. The primary function of the second flame-sprayed layer is to act as an attachment aid and to fix the contact part 10, 11 to said first flame-sprayed layer on each end surface 5, 6.

It should be noted that the dielectric layers 8 and the electrode layers 9 in FIGS. 1 and 2 are only schematically depicted. The number of layers 8, 9 is many times higher than shown in FIGS. 1 and 2.

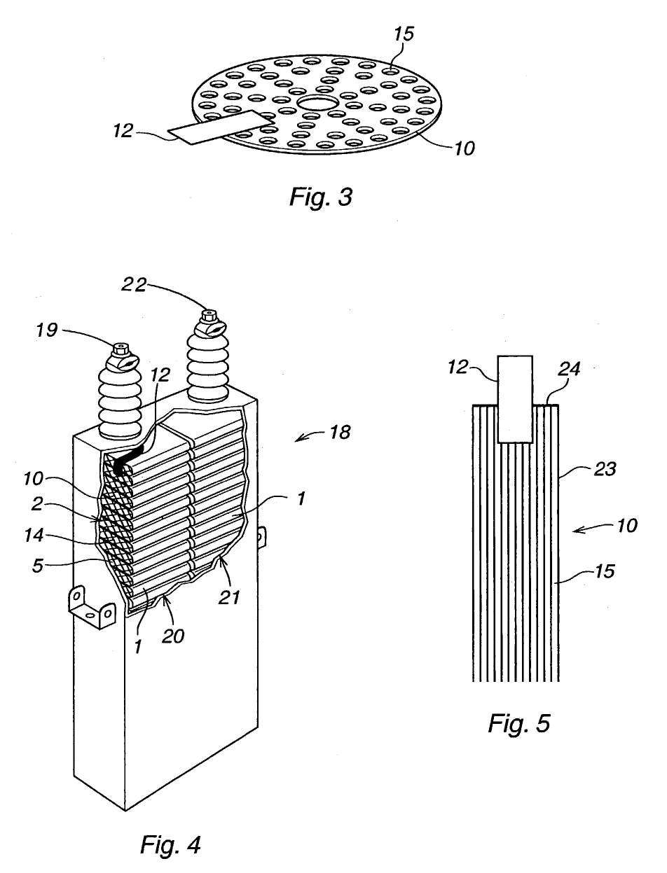

FIG. 3 shows a contact part 10 in accordance with a second embodiment of the invention, which contact part 10 can be used instead of the contact parts 10, 11 shown in relation to FIGS. 1 and 2. The contact part 10 in this case consists of a substantially circular metal plate, preferably of aluminium, displaying a plurality of through-running openings 15 in the form of holes made through the metal plate. A connection wire 12 is attached to the contact part 10.

The processes described above in accordance with the invention procure a range of advantages compared to conventional electric connection techniques. When the attachment aid 17 consists of flame-sprayed metal material, the contact parts 10, 11 reinforce this, which renders the flame-sprayed material less prone to come loose from the end surfaces 5, 6, for instance when extreme discharge currents occur in the capacitor element 1. Attaching the connection wires 12, 13 to the contact part 10, 11 before it is arranged at the end surface 5, 6 avoids the need for a soldering procedure that can damage the electrode layers 9 and the dielectric layers 8. Moreover, this procedure is less complicated and takes less time than the soldering of a busbar directly onto the flame-sprayed metal cake required previously.

FIG. 4 shows a first embodiment of a capacitor 18, in which the technique described above is employed to provide an electric coupling between a first connection terminal 19 and a first stack 20 of flattened capacitor elements 1 placed one above the other. The capacitor elements 1 in the first stack 20 are arranged so that their end surfaces 5 coincide in one plane. A contact element 2 is arranged in this plane. The contact element 2 comprises a contact part 10, having a substantially rectangular shape and extending substantially coextensively with the height of the stack 20. The contact part 10 consists of a plurality of metal threads 14, arranged in a mesh-like structure, like the contact parts 10, 11 described in conjunction with FIGS. 1 and 2. The contact part 10 is in electric contact with all the capacitor elements 1 encompassed in the stack 20 and is attached to these by means of an attachment aid such as has previously been described. A connection wire 12 is at one of its ends attached to the contact part 10 and at its other end to the connection terminal 19. Preferably, a second stack 21 of capacitor elements 1, similarly encompassed in the capacitor 18, is electrically connected to another connection terminal 22. Preferably, the capacitor elements 1 in the stack 20 are also similarly electrically connected to the capacitor elements 1 in the stack 21.

An alternative embodiment of a contact part for an application where several capacitor elements are connected to a connection point is shown in FIG. 5. The contact part 10 in this case consists of a plurality of parallel metal threads 23 that are joined with a transverse metal thread 24, which contact part 10 can be arranged instead of the contact part 10 shown in conjunction with FIG. 4. The through-running openings 15 of the contact part 10 in this case consist of the elongate interspaces between the parallel metal threads 23. The connection wire 12 is suitably arranged by the short side where the transverse metal thread 24 runs, as shown in FIG. 5.

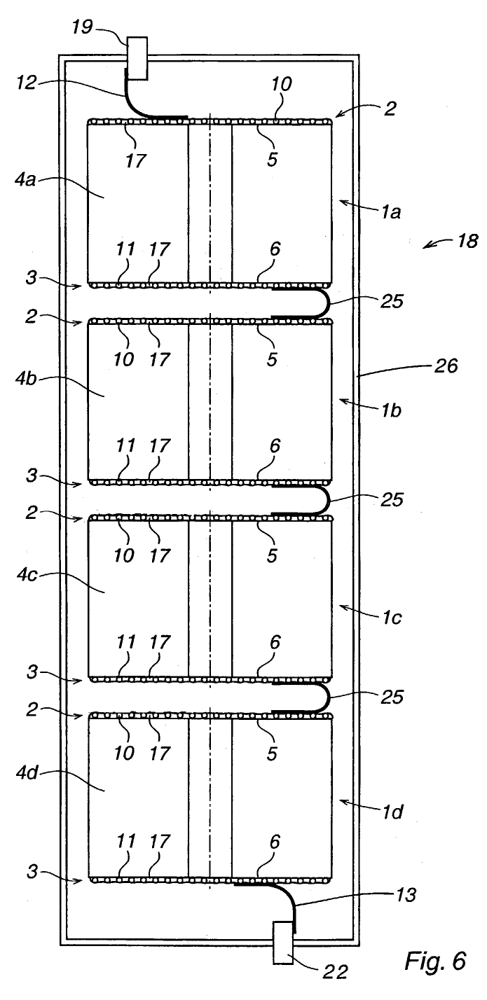

FIG. 6 shows schematically yet another capacitor 18 in accordance with the invention, which comprises a plurality, in this case four, capacitor elements 1a-1d in the form of substantially annular-cylindrical rolls 4a-4d of the type described in conjunction with FIGS. 1 and 2. The capacitor elements 1a-1d are arranged one above the other so that their central axes coincide. At the end surfaces 5, 6 of the rolls 4a-4d, contact elements 2, 3 of the previously described type, i.e. comprising a contact part 10, 11 which prior to being assembled displays a plurality of through-running openings, a connection wire 12, 13, 25, and an attachment aid 17, are electrically connected to electrically connectable electrode layers, which for the sake of clarity are not shown in the drawing, at the end surfaces 5, 6. Preferably, the attachment aid 17 is a flame-sprayed metal material, as previously described. Adjoining capacitor elements 1a-1d are electrically connected to each other through connection wires 25 at the end surfaces 5, 6. The capacitor elements 1a-1d thereby form a series-connected stack. The capacitor 18 further comprises a container 26, with a substantially annular-cylindrical shape, in which the stack of capacitors 1a-1d is enclosed so that the central axes of the capacitor elements 1a-1d and the container 26 coincide. The container 26 is preferably made of an electrically insulating material and is provided at each end with a connection terminal 19, 22, which also acts as bushing in the container 26. The capacitor elements 1a and 1d are electrically connected to one each of the connection poles 19, 22 by the connection wires 12, 13.

In accordance with an alternative embodiment of the capacitor 18 in FIG. 6, the connection wires 25 are omitted and electric connection between adjoining capacitor elements 1a-1d is obtained by causing opposing contact parts 10, 11 to contact each other directly. An axial, compressive force is preferably applied to the stack to achieve requisite contact force.

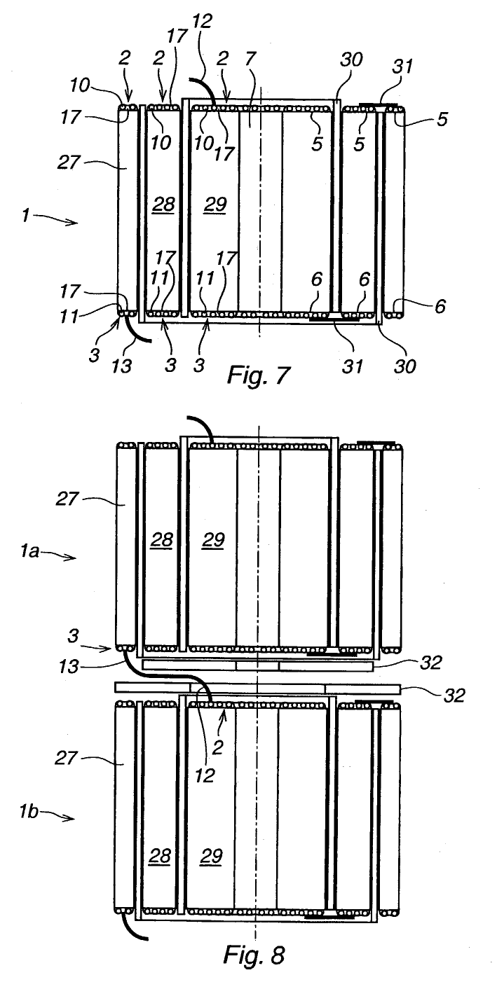

FIG. 7 shows a longitudinal section of an alternative embodiment of a substantially annular-cylindrical capacitor element 1. The capacitor element 1 is divided into three sub-elements 27, 28, 29, in the form of rolls arranged concentrically in one another. The outermost sub-element 27 is essentially tubular and surrounds the intermediate sub-element 28, slightly spaced from it. The intermediate sub-element 28 similarly surrounds the innermost sub-element 29. The innermost sub-element 29 has a through-running central channel 7. Each sub-element 27, 28, 29 displays two end surfaces 5, 6 that are substantially parallel. The different sub-elements 27, 28, 29 are of different radial thickness with the outermost one, 27, being the thinnest. They thus have substantially the same capacitance. Insulation 30 is arranged between adjoining sub-elements 27, 28; 28, 29. On each of the end surfaces 5, 6, of the sub-elements, a contact element 2, 3, comprising a contact part 10, 11, a connection wire 12, 13, 31, and an attachment aid 17, is arranged in electric contact with connectable electrode layers (not shown) on the end surface as previously described. The sub-elements 27, 28, 29 are connected in series. Two radially adjoining sub-elements are electrically connected at the same end. Accordingly, the outermost sub-element 27 is connected by means of a connection wire 31 to the intermediate sub-element 28 at one end of the capacitor element 1, and the intermediate sub-element 28 is by means of a connection wire 31 connected to the innermost sub-element 29 at the other end of the capacitor element 1. If the number of sub-elements is greater than three, for instance five or seven, the ends of the sub-elements should be coupled together alternately in like manner. A connection wire 13 for connection to an external connection point (not shown) extends from the contact part 11 of the outer sub-element 27. A connection wire 12 extends in like manner from the contact part 10 of the inner sub-element 29.

FIG. 8 illustrates how a plurality of capacitor elements of the type shown in FIG. 7 are coupled in 12 series with each other. The figure shows two such capacitor elements 1a, 1b. The connection wire 12 of the lower capacitor element 1b, in FIG. 8, at the upper contact element 2 of the inner sub-element 29, is coupled to the connection wire 13 of the upper capacitor element 1a, by the lower contact element 3 of the outer sub-element 27. Insulation 32 is arranged between the capacitor elements 1a, 1b to ensure that sufficient electric strength is provided.

Preferably, said flame-sprayed material comprises a zinc alloy, a molybdenum alloy, a silver alloy, a carbon compound, a copper alloy, an aluminium alloy or a mixture thereof.

The invention can be applied to impregnated as well as unimpregnated capacitor elements, and to capacitors for alternating current or direct current usage.

Preferably, said capacitors are power capacitors, which term in this context refers to capacitors for voltages exceeding 400 volt, preferably at least 1000 volt. Said capacitor elements are primarily intended for power capacitors.

1. A capacitor including at least one capacitor element (1) that includes at least one roll (4) of alternate dielectric layers (8) and electrode layers (9), which roll (4) has first and second end surfaces (5, 6), facing away from each other, in which said electrode layers (9) are connectably exposed, and two contact elements (2, 3) that are electrically connected to the electrode layers (9) at the end surfaces (5, 6), characterized in that at least one of the contact elements (2, 3) includes a contact part (10, 11) which, before being connected to the electrode layers (9) at the end surface (5, 6) as aforesaid, displays a plurality of through-running openings (15) in which an electrically conducting attachment aid (17) in the form of a flame-sprayed metal material is affixed to attach the contact part (10, 11) to the end surface (5, 6).

2. A capacitor as claimed in claim 1, characterized in that the contact part (10, 11) consists of metal threads (14, 23, 24) that are electrically connected to each other, the through-running openings (15) being arranged between the metal threads (14, 23, 24).

3. A capacitor as claimed in claim 2, characterized in that the metal threads (14) form a mesh-like structure and in that said openings (15) consist of the interstices in the mesh-like structure.

4. A capacitor as claimed in claim 2, characterized in that the metal threads (23) are parallel and in that the through-running openings (15) are arranged in elongate spaces between the parallel metal threads (23).

5. A capacitor as claimed in claim 1, characterized in that the contact part (10, 11) consists of a metal plate and in that said openings (15) consist of a plurality of holes made through the plate.

6. A capacitor as claimed in any one of the claims 1-5, characterized in that the flame-sprayed metal material includes a zinc alloy, a molybdenum alloy, a silver alloy, a carbon compound, a copper alloy, an aluminium alloy, or a mixture thereof.

7. A capacitor as claimed in any one of claims 1-6, characterized in that it includes at least two of said capacitor elements (1) and in that the contact part (10, 11) is attached to each of said at least two capacitor elements (1).

8. A capacitor as claimed in any one of claims 1-6, characterized in that it includes at least two of said capacitor elements (1) and in that these have a substantially annular-cylindrical shape, are arranged one above another so that their central axes coincide, and are connected to each other so as to form a series-connected stack of capacitors.

9. A capacitor as claimed in any one of claims 1-6, characterized in that the capacitor element (1) includes a plurality of sub-elements (27, 28,-29) arranged concentrically in relation to each other, such that the outermost of radially adjacent sub-elements has a central through-running channel with substantially annular-cylindrical shape that closely abuts the inner sub-element.

10. A capacitor as claimed in claim 9, characterized in that the number of sub-elements (27, 28, 29) in the capacitor element (1) is uneven and in that these are coupled in series with each other.

11. A capacitor as claimed in any one of claims 1-10, characterized in that the dielectric layers (8) and the electrode layers (9) consist of metallized dielectric film.

12. A capacitor as claimed in any one of claims 1-11, characterized in that it is a power capacitor.

13. A process, in relation to a capacitor element (1) that includes a roll (4) of alternate dielectric layers (8) and electrode layers (9), which roll (4) has first and second end surfaces (5, 6), facing away from each other, in which said electrode layers (9) are connectably exposed, for electrically connecting the electrode layers (9) at one of the end surfaces (5, 6) to a predetermined connection point, characterized in that it includes the steps of:
a) attaching a first end of an electrically conducting connection wire (12, 13, 25, 31) to a contact part (10, 11) displaying a plurality of through-running openings (15),
b) arranging the contact part (10, 11) by the end surface (5, 6) in electric contact with the connectable electrode layers (9),
c) attaching the contact part (10, 11) to the end surface (5, 6) with the aid of an attachment aid (17) in the form of a metal material that is flame-sprayed onto the end surface (5, 6) through the through-running openings (15) of the contact part (10, 11) and causing the metal material to solidify and attach the contact part (10, 11) to the end surface (5, 6), and
d) attaching the other end of the connection wire (12, 13, 25, 31) to the predetermined connection point.

14. A process as claimed in claim 13, characterized in that a first metal material is flame-sprayed onto the end surface (5, 6), before step b, to form a first electrically conducting flame-sprayed coating that electrically connects to the electrode layers (9) and in that the contact part (10, 11), in the subsequent steps b and c, is arranged in electric contact with and fixed to the end surface (5, 6) via the first flame-sprayed coating.
